(19) United States
(12) Patent Application Publication
(10) Pub. No.: US 2004/0222965 A1
(43) Pub. Date: Nov. 11, 2004

(54) System and method for generating an analog signal in a hand-held computing device

(76) Inventors: Roy J. Riccomini, Saratoga, CA (US); Allen Lee, Los Altos, CA (US); Timothy D. Twerdahl, Los Altos, CA (US); Robert F. Ebert, San Francisco, CA (US)

Correspondence Address: CARR & FERRELL LLP, 2200 GENG ROAD, PALO ALTO, CA, 94303, US

(21) Appl. No.: 10/840,070

(22) Filed: May 5, 2004

Related U.S. Application Data
(60) Provisional application No. 60/468,447, filed on May 5, 2003.

(51) Int. Cl. G09G 5/00

(52) U.S. Cl. 345/156

(57) ABSTRACT

A system is described for generating an analog signal representing displacement information in a hand-held computing device. In one embodiment, a hand-held computing device includes a housing sized so that a user can hold the computing device during operation. The device also includes a display and a set of controls integrated with the housing so that the user can input information to the device's processor using his or her digits. At least one of the controls is an analog input device configured such that when displaced it generates an analog signal representing that displacement.

### CROSS-REFERENCE TO RELATED APPLICATIONS

This application claims the benefit of Provisional Patent Application Ser. No. 60/468,447, filed May 5, 2003, entitled “System and Method for Generating an Analog Signal in a Hand-Held Computing Device”, which is incorporated herein by reference. This application is also related to U.S. patent application Ser. No. ______, entitled “System and Method for Controlling Polling of a Signal in a Hand-Held Computing Device”, filed May 5, 2004, which is incorporated herein by reference.

### BACKGROUND OF THE INVENTION

1. Field of the Invention

This invention relates generally to hand-held computing devices and more specifically to a system for generating an analog signal representing displacement information of an analog input device included in a hand-held computing device.

2. Description of the Background Art

Hand-held computing devices traditionally run software applications that accept input from digital input devices (i.e., input devices having two states such as “open” or “closed” or “on” or “off”). For example, users typically navigate between and within applications running on hand-held personal digital assistants (PDAs), such as basic record keeping and scheduling software (e.g., address books, phone lists, calendars, memo lists, etc.), by engaging two-state switches (e.g., buttons) representative of up/down or left/right directions. Other types of hand-held computing devices use more sophisticated digital input devices for data input or for controlling the position of various graphics or a cursor on the display screen. Examples of these digital input devices include four-way and eight-way switches.

Recently, hand-held computing devices have been designed to run more graphics-intensive software applications, such as game applications. In such applications, enabling users to input information, such as position information, more precisely and at a higher rate than is achievable using simple, two-state digital input devices is desirable. Typically, desktop and other stationary computing systems provide precise, high-speed control by way of an analog input device, such as a joystick. An analog input device is capable of generating signals having values within a continuous range that typically represents displacement in two orthogonal directions. With an analog input device, for example, a user can input position information in a theoretically infinite number of directions, can control the amount that the position changes in a particular direction, and can control the rate that the position changes in a particular direction. In sum, analog input devices generally are more versatile than digital input devices and therefore enhance the performance of hand-held computing devices that run video games and other similar software.

However, using analog input devices in hand-held computing devices has been historically disfavored largely because analog input devices are typically too physically large to be practically integrated into a hand-held computing device. Typical two-axis analog potentiometers include a potentiometer for each axis, a gimballing mechanism, and self-centering springs. Such analog input devices are typically on the order of 20 mm×20 mm×20 mm or larger, which forces the overall hand-held computing device package to be too unwieldy for comfortable hand-held operation. Further, in a game application, an analog joystick generally has a long control “shaft” so that a game player has sufficient leverage to control the motion of the analog input device in order to direct the motion of figures in the game. Such a long shaft makes transport or handling of the device awkward or impractical. A long shaft also makes it impractical to contain a hand-held computing device incorporating an analog input device in a protective sheath, carrying container, or pocket of the user.

Furthermore, typical two-axis analog potentiometers have production variances that prevent their predictable integration into hand-held computing devices. Such variances can arise from imperfections in the mechanical centering or gimballing employed, or in variations of resistance with respect to mechanical position of the shaft of the analog input device.

Therefore, a need exists in industry to address the aforementioned deficiencies and inadequacies.

### SUMMARY OF THE INVENTION

The present invention provides a system and method for generating analog signals in a hand-held computing device. The hand-held computing device includes a housing sized to be held in the hands of a user during operation of the device, where the housing has an upper surface defining a first plane, a display disposed at or near the upper surface of the housing, and a set of controls integrated with the housing for providing user input to a processor. The set of controls is positioned about the housing so that the user can manipulate the controls with his or her digits. The set of controls includes at least one analog input device that generates an analog signal that represents displacement information of the analog input device when manipulated by the user.

The method for calibrating an analog input device of a hand-held computing device includes a first step of reading a neutral value corresponding to a null position of the analog input device. Next, values corresponding to the maximum deflection of the analog input device in a first and a second mutually orthogonal dimension are read. Then, the values read are mapped to a range of digital values. Finally, a dead zone is computed to correspond to slight deflection of the analog input device.

One advantage of this system and method is that users are able to input information to the processor, such as position information of a graphic element represented on the display, more precisely and at a higher rate using an analog input device than is achievable using, for example, standard, two-state digital input devices. This capability, as well as the increased versatility of analog input devices, enhances the performance of hand-held computing devices that run video games and other similar software.

### BRIEF DESCRIPTION OF THE DRAWINGS

FIG. 1 is a top plan view illustrating one embodiment of a hand-held computing device, according to the present invention;

FIG. 2 is a partial cross-sectional view illustrating one embodiment of the analog input device of FIG. 1, according to the present invention;

FIG. 3A and FIG. 3B are partial cross-sectional views illustrating an alternative embodiment of the analog input device of FIG. 1;

FIG. 3C is a diagram illustrating the mechanical travel of an analog input device of FIG. 3A and FIG. 3B;

FIG. 3D is a top plan view illustrating one embodiment of the rubber cover of FIG. 3A and FIG. 3B;

FIG. 4A is a flowchart illustrating an exemplary method for calibrating the analog input device of FIG. 1; and

FIG. 4B is a diagram illustrating the mapping of calibration data in accordance with the method of calibration of the analog input device as depicted in FIG. 4A.

### DETAILED DESCRIPTION OF THE INVENTION

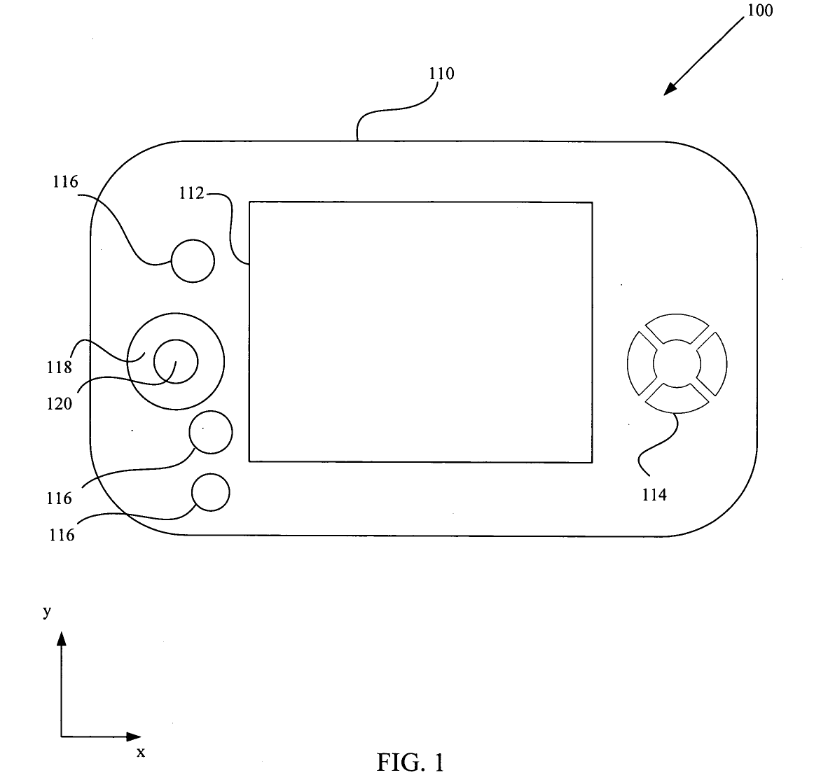

FIG. 1 is a top plan view illustrating one embodiment of a hand-held computing device 100, according to the present invention. As shown, the hand-held computing device 100 may include, without limitation, a housing 110, a display 112, a four-way digital input device 114, one or more digital input devices 116, and an analog input device 120. The housing 110 can be made of any type of suitable material such as plastic, metal, or hard rubber, and is sized such that a user can comfortably hold the hand-held computing device 100 during operation.

The four-way digital input device 114 allows the user to input various types of information into the hand-held computing device 100 by pressing any of the four buttons associated with the four-way digital input device 114. In particular, the four-way digital input device 114 is conducive for inputting direction-oriented information into the hand-held computing device 100. For example, depending on the software application running on the hand-held computing device 100, the user can move a cursor or other graphics object in any one of four directions (i.e., up, down, left, or right) within the display 112 by pressing the button corresponding to that direction. Similarly, the user can use the four-way digital input device 114 to scroll up and down a given display screen by pressing on the top and bottom buttons, respectively.

The user also can input various types of information into the hand-held computing device 100 by pressing on any one of the digital input devices 116. For example, depending on the software application running on the hand-held computing device 100, the user can select a particular graphics object by pressing one of the digital input devices 116 once the cursor highlights that graphics object. Similarly, while playing a video game, the user can press one or more of the digital input devices 116 to fire a gun, pick up or select objects within the game, or to make the user's gaming character perform some function like kicking or punching.

The analog input device 120 allows the user to input information into the hand-held computing device 100 simply by exerting force which results in displacement of the analog input device 120 in a specific direction. The analog input device 120 is particularly useful when the user is playing a video game on the hand-held computing device 100. For example, a user can input position information in any desired direction using the analog input device 120, thereby allowing the user to direct movement of a character or other graphic object in any direction within the display 112. With the analog input device 120, the user is not limited to only the up, down, left, or right directions. Further, the user can control an amount that the character or other graphic object moves and/or a speed at which that character or other graphic moves within the display 112. For example, in response to a user moving the analog input device 120 slightly from center, a graphic element can move slightly or slowly in that direction, versus a far and rapid movement when the analog input device 120 is moved to the maximum deflection. In addition, the user can change the direction in which the character or other graphic object moves simply by exerting force on a portion of the analog input device 120.

Other applications for the analog input device 120 include, for example, “radial menus” in which navigation is by radially arranged menu options, which may be nested into hierarchical levels of menus. Radial menus are described in more detail in co-pending U.S. patent application Ser. No. ______, entitled “Radial Menu Interface for Handheld Computing Device.”

Additionally, variable speed scrolling is another exemplary application for the analog input device 120 in the hand-held computing device 100. Variable speed scrolling is particularly useful when a user is reading a text document, such as an electronic book. By moving the analog input device 120 slightly from center, the text displayed on the display 112 advances or “scrolls” slowly. In contrast, by moving the analog input device 120 further from center, the text advances rapidly. Variable speed scrolling is easier to use than repeatedly pressing one of the digital input devices 116 to advance or scroll through a page of text.

In the embodiment of FIG. 1, the analog input device 120 is shown partially disposed in a well 118. Among other things, such a configuration allows the user to more easily and comfortably manipulate the analog input device 120 while holding the hand-held device 100. In alternative embodiments, the analog input device 120 may be located anywhere on the face of the hand-held device 100. It should be noted that FIG. 1 illustrates an exemplary embodiment of the hand-held input device 100. Alternative embodiments may comprise more or fewer input devices (e.g., 114, 116, 120), and may arrange the input devices in a different manner on the hand-held computing device 100. In alternative embodiments, the analog input device 120 may be implemented as a trackball or a joystick of any shape, and the well 118 may have any shape and/or be any size.

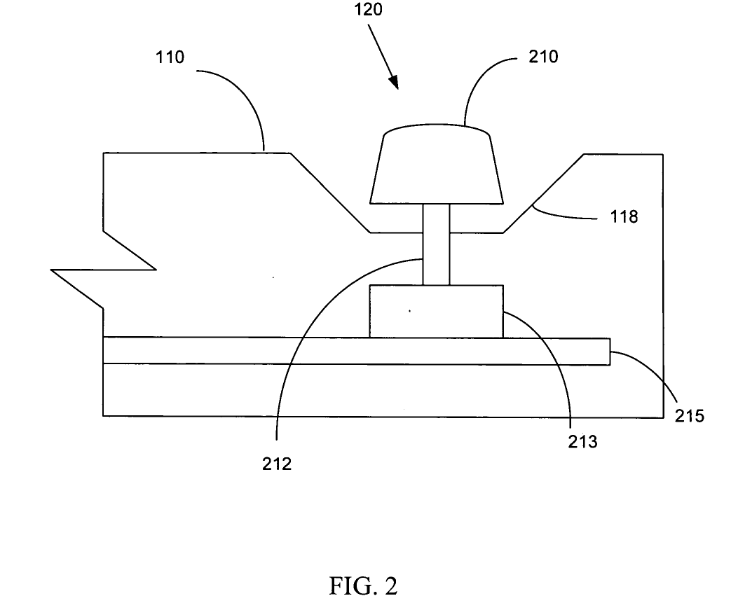

FIG. 2 is a partial cross-sectional view illustrating one embodiment of the analog input device 120 of FIG. 1. As shown, the analog input device 120 may be implemented in a form of a joystick having a cap 210 that is attached to, or formed integrally with, a proximal end of a shaft 212. The shaft 212 is pivotally secured to a base 213 at an opposite end. The base 213 is oriented within the hand-held computing device 100 such that displacement of the shaft 212 produces a corresponding analog signal in circuitry (not shown) residing within the hand-held computing device 100. The shaft 212 can be mechanically biased (by springs or similar expedient) to return to a baseline or return position in the absence of user-exerted force. The base 213 can also comprise gimballing assemblies, centering springs, and two-axis potentiometers, and can be coupled to a printed circuit board (“PCB”) 215. In an exemplary embodiment in accordance with the present invention, the analog input device 120 also incorporates a switch (not shown) that is activated by pressing down on the cap 210.

Those skilled in the art will recognize that the analog signal generated by the analog input device 120 may comprise two or more signals, each signal corresponding to a displacement of the analog input device 120 in a specified direction. For example, as described in further detail herein, the signal generated by the analog input device 120 may comprise x-axis and y-axis signals. Further, the x-axis and y-axis are merely illustrative, may be redefined without changing the scope of the present invention, and need not be orthogonal. It will be appreciated that an analog-to-digital converter (not shown) can convert the analog signal to a digital signal for a processor of the hand-held computing device 100.

In one embodiment, the well 118 is generally frustro-conical and opens outwardly and upwardly. Further, the upper end of the well 118 is large enough so that the user can move the analog input device 120 through its entire range of motion without the user hitting his or her thumb or finger (whichever is being used to move the analog input device 120) on the housing 110. In some embodiments, the well 118 may be angled with respect to the housing 110 so that the well 118 is deeper on one end. Alternatively, the well 118 may be shaped to provide an asymmetrical well 118 about the analog input device 120.

The analog input device 120 is preferably disposed partially in the well 118 such that the cap 210 does not protrude substantially above the surface of the housing 110. In one embodiment, the cap 210 protrudes above the surface of the housing 110 by approximately 1.8 mm. The amount by which the cap 210 protrudes above the surface of the housing 110, however, may vary and is a function of several factors, not limited to the following. A substantial amount of protrusion, for example, would make the hand-held computing device 100 less portable because a protective carrying case containing the hand-held computing device 100 would have to be larger (i.e., thicker) to accommodate the protrusion. Furthermore, increased protrusion may lead to inadvertent operation of the analog input device 120 during handling or carrying by the user when the hand-held computing device 100 is not contained within a protective case. Inadvertent operation of the analog input device 120 may lead to increased usage of processor resources and battery drain. Further, the more that the cap 210 protrudes, the more susceptible the cap 210 would be to snag (e.g., on pants or shirt pockets) or be hit by other objects, increasing the risk of damage to the analog input device 120. Further, increased protrusion increases an amount of force applied to the shaft 212, potentially causing breakage or damage to the analog input device 120 or particularly to the shaft 212 or the base 213.

On the other hand, less protrusion above the surface of the housing 110 may decrease the range of motion of the analog input device 120. Users generally prefer a greater range of motion, especially when playing video games, because a greater range of motion tends to make video games feel more interactive. A decreased range of motion, among other things, reduces the resolution of the analog input device 120, and adversely affects the performance of the hand-held computing device 100.

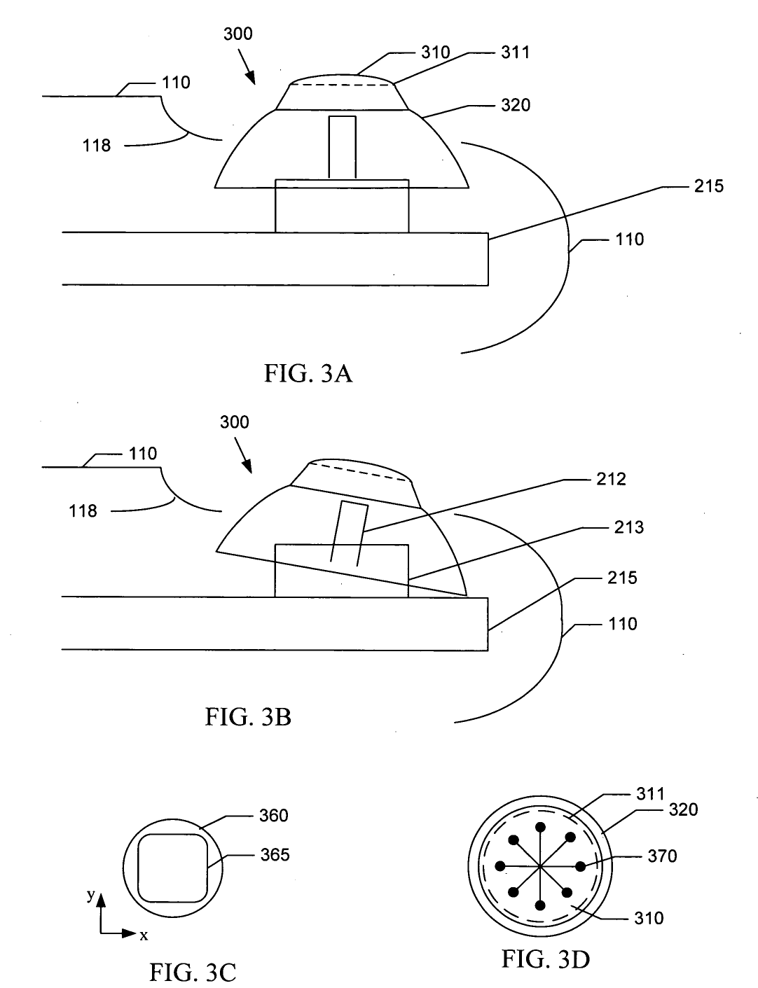

FIG. 3A and FIG. 3B are cross-section views of an alternative embodiment of the analog input device 120, showing further detail on a cap 300 and the integration into the housing 110. In this embodiment, the cap 300 is comprised of a rubber cover 310 coupled to a dome 320. The dome 320 provides a mechanical interface onto the shaft 212. The dome 320 further has a “skirt” resulting from a hollow backside that extends into a cavity formed by the well 118. In one embodiment, the dome 320 is plastic, although it may be any suitable material.

In this embodiment, as shown in FIG. 3B, as a result of the user forcing the cap 300 to maximum deflection, the circumference of the skirt of the dome 320 contacts the PCB 215 so as to act as a positive mechanical “stop,” limiting travel of the cap 300 and the shaft 212. This has several benefits. As shown in FIG. 3C, the user experiences truly circular maximum deflection 360 of the cap 300 in the x-y plane, rather than a rounded-rectangular travel 365 of a typical two-axis potentiometer. Because the dome 320 and the PCB 215 limit force exerted by the user, only a limited amount of force can be imparted onto the shaft 212 and the base 213, thereby preventing damage to either the shaft 212 or the base 213. Limiting the force to the shaft 212 and the base 213 allows the physical size of these parts to be reduced. Further, in the embodiment of FIG. 3A and FIG. 3B, the skirt of the dome 320 is wider than the hole formed by the well 118. This prevents the user from seeing electronics or other components of the hand-held computing device 100 (FIG. 1) contained within the housing 110 when the cap 300 is manipulated during use. The dome 320 and the well 118 also combine to prevent dirt and other foreign matter from getting into the housing 110. The hollow backside of the dome 320 further minimizes the protrusion of the analog input device 120 above the plane of the housing 110, allowing for a thinner housing 110.

The rubber cover 310 coupled to the dome 320 provides several advantages over a single-piece plastic cap, such as the cap 210 (FIG. 2). The rubber cover 310 provides a comfortable tactile “feel” to the user. As well, the rubber cover 310 provides traction to prevent the thumb or finger of the user from sliding on the cap 300.

In the embodiment as shown in FIG. 3A, the rubber cover 310 has a convex upper surface as well as a definite edge 311. The rubber cover 310 may have a flat or concave top, but the convex surface generally improves tactile feel and traction. Providing the rubber cover 310 for the cap 300 is particularly important for gaming, as the thumb or fingers of the user can become sweaty or greasy during aggressive game play. Further, providing the definite edge 311 for the rubber cover 310 makes it easier for the user to force the analog input device 120 to maximum travel. An alternative embodiment consists of the entire cap 300 in rubber or other material that provides an effective tactile “feel” and mechanical properties as described above.

FIG. 3D illustrates a top plan view of one embodiment for the cap 300 in which a top surface of the rubber cover 310 further includes indentations 370. Although in one embodiment, the indentations 370 are arranged in an 8-pointed star, the indentations 370 can be arranged in any layout, or provide a logo. In one embodiment, the indentations 370 match a “radial menu” user interface shown on the display 112 (FIG. 1) by the software of the hand-held computing device 100. Matching the indentations 370 with the user interface shown on the display 112 provides an indication to the user about the use of the analog input device 120 in hand-held computing device 100. Alternatively, the indentations 370 could include or be replaced by raised “bumps” to improve tactile feel and traction.

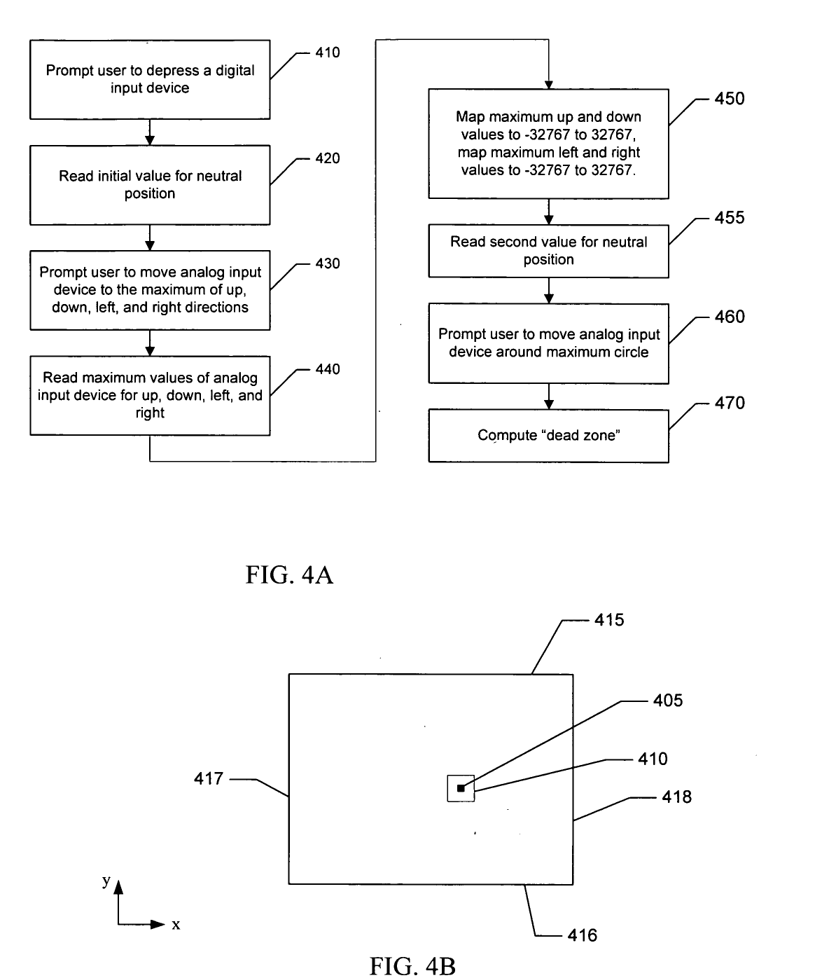

FIG. 4A and FIG. 4B illustrate one embodiment of a method for calibrating the analog input device 120 (FIG. 1) of the hand-held computing device 100 (FIG. 1). Such calibration is advantageous because of production variations in typical two-axis potentiometers included in the analog input device 120, variances in the analog input device 120 in combination with the cap 210 or 300 and the PCB 215, and/or variations in analog-to-digital (“A/D”) converters (not shown) that digitize the analog input device 120 for the processor of the hand-held computing device 100.

As is well known in the art, input to the software of the hand-held computing device 100 can be provided using an A/D converter coupled to a potentiometer of the analog input device 120. In one embodiment in accordance with the present invention, dual A/D converters are coupled to two-axis potentiometers included in the analog input device 120 to generate y-axis and x-axis digital values corresponding to a position of the shaft 212. Dual 10-bit A/D converters yield digital values in a range 0 to 1023 for the y-axis and 0 to 1023 for the x-axis. As will be clear to a skilled artisan, the range of digital values can be scaled up or down in accordance with the bit-precision of the A/D converter, or a single multiplexer A/D converter can replace dual A/D converters.

As shown in the method of FIG. 4A, at step 410, an initial value for a neutral position is read. The initial neutral value corresponds to an electromechanical “center” of the two-axis potentiometer, as well as an electrical “center” of the digital values of the A/D converter. The software of the hand-held computing device 100 at step 420 reads the initial neutral value. The initial neutral value read by the software of the hand-held computing device 100 at step 420 is depicted in FIG. 4B as center 405. Reading the initial neutral value can be accomplished, upon entering a calibration mode in the software of the hand-held computing device 100, by a message displayed on the display 112 (FIG. 1) for the user to depress one of the digital input devices 116 (FIG. 1). This forces the fingers of the user off of the analog input device 120 and gives an initial neutral value.

Next, at step 430, a message is displayed on the display 112 for the user to sequentially move the analog input device 120 to its maximum deviation in the “up,” “down,” “left,” and “right” directions, although not necessarily in this order. At step 440, the software reads digital values corresponding to the maximum travel of the analog input device 120, depicted as 415, 416, 417, and 418, respectively, in FIG. 4B. Steps 430 and 440 are provided because the cap 210 or 300 of the analog input device 120 can limit the available range of digital values corresponding to maximum physical travel of the analog input device 120. In other words, although the A/D converters can generate digital values in the range 0 to 1023, the actual digital values read in step 440 can be less (e.g., 15 to 987 in the y-axis, and 25 to 1004 in the x-axis). Steps 430 and 440 establish the extremes of the digital values (i.e., y+, y-, x- and x+) along the y-axis and x-axis.

At step 450, the software maps the digital values corresponding to the maximum physical travel of the analog input device 120 to a 16 bit (signed) calibrated range from −32767 to +32767 for the y-axis and a 16 bit (signed) calibrated range from −32767 to +32767 for the x-axis. As is depicted in FIG. 4B, the initial neutral value 405 is not necessarily centered within the digital values corresponding to the maximum travel of the analog input device 120, depicted as 415, 416, 417, and 418. Mapping is performed to center the calibrated range with respect to the initial neutral value read in step 420, and to scale the calibrated range with respect to the maximum values read in step 440.

With respect to the y-axis, the software maps the digital value corresponding to the maximum “down” position of the analog input device 120 (e.g., the −y value, depicted as 416 in FIG. 4B) to −32767, and maps the digital value corresponding to the maximum “up” position of the analog input device 120 (e.g., the +y value, depicted as 415 in FIG. 4B) to +32767. The initial neutral value (depicted as 405 in FIG. 4B) is mapped to 0. Because the digital values are not necessarily centered with respect to the y-axis, a scaling factor is computed independently for the “up” range and the “down” range. In similar fashion, the software scales the x-axis. As will be clear to a skilled artisan, the calibrated range can be scaled up or down (i.e., provide more or fewer than 16 bits of precision) in accordance with the desired bit-precision of the software, and the resolution in the y-axis need not be the same as the resolution in the x-axis.

At step 455, a second neutral value is read. The second neutral value will be discussed below in conjunction with the dead zone computation of step 470. At step 460, the user is prompted to move the analog input device 120 entirely around the maximum circumference of travel. It is possible in steps 410 through 450 to produce values in the calibrated range that do not correspond to the maximum travel of the analog input device 120 at the “corners” (e.g., maximum in x and maximum in y, minimum in x and maximum in y, etc.) of the x-y space. For example, unexpected calibration values can result from a bad component, user error, and/or a user intentionally trying to generate an abnormal calibration such as by moving the analog input device 120 in the wrong direction or not pushing it fully to the limit. Step 460 validates that the user can “hit the corners” since maximum and minimum readings are not taken at 45 degree angles in the x-y space. Step 460 also verifies that the analog input device 120 is operating properly after calibration is applied in step 450.

In one embodiment, at step 460, the display 112 presents eight target arc segments (not shown) spaced in a circular fashion, and the user is requested to highlight each target arc segment by moving the analog input device 120 around the maximum circumference of travel long enough for each target arc segment to change color. Software of the hand-held computing device 100 needs just one digital value corresponding to the target arc segment to verify the correct calibration of the analog input device 120. The calibration samples 20 times per second in some embodiments, so the user does not have to hold a position for very long. The software of the hand-held computing device 100 does not allow the user to complete the calibration until all target arc segments are selected. For example, if the user does not push the analog input device 120 all the way to the mechanical stops during step 430, the calibration data will be “too gentle.” In this case, the analog input device 120 may render maximum values in the calibrated range before the full limit of physical travel of the analog input device 120 is reached. Conversely, if the calibration is “too broad,” the analog input device 120 may not be able to hit the target arc segments in all eight directions.

In an alternative embodiment, at step 460, a cursor on the display 112 indicates the position of the analog input device 120 in x-y space, and the user is prompted to manipulate the cursor onto a number of targets arranged on the display 112 by moving the analog input device 120. Numerous different graphic treatments can be applied, including fewer or more targets, targets closer and further from the center, etc., in order to validate that the analog input device 120 can generate digital values corresponding to the entire x-y space. In another embodiment in accordance with the present invention, step 460 is skipped entirely.

At step 470, the software determines a “dead zone” for which slight physical deflections of the analog input device 120 are ignored as essentially “noise.” Such slight deflections can arise from a user resting his thumb or finger on the analog input device 120, but without intentionally deflecting the analog input device 120. The software maps values for the dead zone so that slight deflections of the analog input device 120 do not result in movement of a cursor or other graphic element in the display 112. The dead zone around the initial neutral value is graphically depicted as element 410 in FIG. 4B.

The dead zone is computed for each of the +x, −x, +y, and −y directions independently, and fine-tunes the mapping performed in step 450. When the initial neutral value measurement is taken at step 420, an “initial dead zone” of 1/32 of the full range of calibrated values (i.e., 32767/32=1024 states, or about 3%), is added in each of the +x, −x, +y, and −y directions. In other words, the initial dead zone is centered at the neutral value, extending 1024 states in the +x, −x, +y, and −y directions. Then, as each maximum measurement is taken at step 440, a “maximum zone” of 1/32 of the calibrated range (i.e., 1024 states) is removed from the calibrated maximum values. The result of the initial dead zone is that the user must deflect the analog input device 120 about 3% away from the neutral position before the software detects any movement of the analog input device 120. As a result of the maximum zone, the software detects maximum values when the user is within 3% of the maximum deflection of the analog input device 120.

Because the gimballing mechanisms and two-axis potentiometers of the analog input device 120 do not return consistently to an exact neutral position, the dead zone computation also takes into consideration the re-centering of the analog input device 120. After the maximum values are read at step 450, the analog input device 120 returns to center. A second neutral value is read at step 455. If the second neutral value falls within the initial dead zone, then no further calibration is needed. However, if after 15 successive samples, for example, the digital values corresponding to the position of the analog input device 120 are outside the initial dead zone, then the dead zone is expanded to encompass a 1/32 margin (i.e., 1024 states) around the initial neutral value plus the second neutral value. For example, if the second neutral value is ⅓ of the way towards the −y maximum, then the dead zone will be expanded to become a long strip from the initial dead zone to ⅓ of the way towards the −y maximum, with a 1/32 margin around the long strip. Put another way, the dead zone is not extended in 1/32 increments, but instead expands from the initial neutral value to include the second neutral value plus an additional 1/32 margin. Step 470 ensures that the analog input device 120 will always returns to the final dead zone when released, and may cause the final dead zone size to be larger than the initial dead zone. If the initial neutral value, the second neutral value, and/or the final dead zone do not fall within an acceptable range, the analog input device 120 can be rejected as defective.

During each of the above method steps when software is reading the input from the analog input device 120, the user is prompted to hold the analog input device 120 in a particular position for a period sufficient that the software can obtain adequate data samples from the analog input device 120.

It should be noted that the method of FIG. 4A is exemplary. Alternatively, the steps may be modified, performed in a different order, or some steps may be omitted. For example, the dead zone computation described above with respect to step 470 may utilize a dead zone of other than 1/32 or 1/16, or may utilize different computations for the x-axis than for the y-axis.

In a further embodiment in accordance with the present invention, in order to save processor resources with the device in a low power or “sleep” mode, deflecting, depressing, or otherwise activating the analog input device 120 does not cause the hand-held computing device 100 to turn “on.” This is particularly advantageous since the analog input device 120 is likely to be inadvertently displaced when the user is transporting or handling the hand-held computing device 100, for example when the hand-held computing device 100 is contained in a clothing pocket of the user.

The invention has been described above with reference to specific embodiments. Those skilled in the art, however, will understand that various modifications and changes may be made thereto without departing from the broader spirit and scope of the present invention. For example, although the embodiments set forth above implement an analog device that generates signals representative of displacement in two orthogonal directions (i.e., x-axis and y-axis signals), the system and method of the present invention may also implement analog devices that generate signals representative of displacement in a lesser or greater number of dimensions. The foregoing description and drawings therefore should be regarded in an illustrative rather than a restrictive sense.

What is claimed is:

1. A hand-held computing device, comprising:
a housing sized to be held in hands of a user during operation of the device, the housing having an upper surface defining a first plane;
a display disposed on the upper surface of the housing; and
a set of controls integrated with the housing for providing user input to a processor, the set of controls being positioned about the housing so as to enable manipulation by digits of the user, the set of controls including at least one analog input device for generating an analog signal representing displacement information.

2. The hand-held computing device of claim 1, wherein the analog input device comprises a joystick terminating at its upper end in a cap.

3. The hand-held computing device of claim 2, wherein the cap comprises a convex-shaped top.

4. The hand-held computing device of claim 2, wherein the cap comprises a concave-shaped top.

5. The hand-held computing device of claim 2, wherein the cap is disposed at least partially in a well located within the upper surface such that the cap does not protrude substantially above the first plane.

6. The hand-held computing device of claim 2, wherein the cap is disposed at least partially in a well defined by a portion of the upper surface such that the cap does not protrude substantially above the first plane.

7. The hand-held computing device of claim 1, wherein the analog input device comprises a trackball.

8. The hand-held computing device of claim 1, wherein the at least one analog input device is configured to generate first and second analog signals representative of displacement in a first and a second mutually orthogonal dimension.

9. A hand-held computing device, comprising:
a housing sized to be held in the hands of a user during operation of the device, the housing having an upper surface defining a first plane;
a display disposed on the upper surface of the housing; and
means for providing user input to a processor, the means being positioned about the housing so as to enable manipulation by the digits of the user and configured to generate an analog signal representing displacement information.

10. The hand-held computing device of claim 9, wherein the means for providing user input comprises a joystick terminating at its upper end in a cap.

11. The hand-held computing device of claim 10, wherein the cap is disposed at least partially in a well located within the upper surface such that the cap does not protrude substantially above the first plane.

12. The hand-held computing device of claim 9, wherein the means for providing user input comprises a joystick terminating at its upper end in a cap with a concave-shaped top.

13. The hand-held computing device of claim 9, wherein the means for providing user input comprises a joystick terminating at its upper end in a cap with a convex-shaped top.

14. The hand-held computing device of claim 9, wherein the means for providing user input comprises a trackball.

15. The hand-held computing device of claim 9, wherein the means for providing user input includes at least one potentiometer.

16. The hand-held computing device of claim 9, further comprising means for limiting force resulting from manipulation by the digits of the user.

17. A method for calibrating an analog input device of a hand-held computing device, the method comprising:
reading a neutral value corresponding to a null position of the analog input device;
reading values corresponding to the maximum deflection of the analog input device in a first and a second mutually orthogonal dimension;
mapping values corresponding to the maximum deflection of the analog input device to a range of digital values; and
computing a dead zone corresponding to slight deflection of the analog input device.

18. The method of claim 17, further comprising receiving via a digital input device a calibration initiation request.

19. The method of claim 17, further comprising prompting the user to manipulate the analog input device.

20. The method of claim 17, further comprising reading values corresponding to maximum circumferential travel of the analog input device.

21. A computer readable medium having embodied thereon a program, the program being executable by a machine to perform a method for calibrating an analog input device of a hand-held computing device, the method comprising the steps of:
reading a neutral value corresponding to a null position of the analog input device;
reading values corresponding to the maximum deflection of the analog input device in a first and a second dimension;
mapping values corresponding to the maximum deflection of the analog input device to a range of digital values; and
computing a dead zone corresponding to slight deflection of the analog input device.

22. The computer readable medium of claim 21, wherein the method further comprises receiving via a digital input device a calibration initiation request.

23. The computer readable medium of claim 19, wherein the method further comprises prompting the user to manipulate the analog input device.

24. The computer readable medium of claim 19, wherein the method further comprises reading values corresponding to maximum circumferential travel of the analog input device.
